(19) United States
(12) Patent Application Publication
(10) Pub. No.: US 2013/0216807 A1
(43) Pub. Date: Aug. 22, 2013

(54) OPTICAL COATING COMPRISING POROUS SILICA NANOPARTICLES

(71) Applicants: Gareth Wakefield, Yarnton (GB); Martin Gardener, Yarnton (GB); Sasha Ostrowski, Yarnton (GB)

(72) Inventors: Gareth Wakefield, Yarnton (GB); Martin Gardener, Yarnton (GB); Sasha Ostrowski, Yarnton (GB)

(73) Assignee: Oxford Energy Technologies Limited, Begbroke (GB)

(21) Appl. No.: 13/817,268

(22) PCT Filed: Aug. 19, 2011
(86) PCT No.: PCT/GB2011/051565

§ 371 Date: Apr. 23, 2013

(30) Foreign Application Priority Data
Aug. 20, 2010 (GB) 1014024.2

(51) Int. Cl. G02B 1/11

(52) U.S. Cl. CPC G02B 1/111
USPC 428/218; 428/313.9; 428/212; 427/162; 106/287.16; 523/466

(57) ABSTRACT

An optical coating comprising a binder and a plurality of porous silica nanoparticles in which the pores are randomly oriented, a solution for forming an optical coating comprising a solvent and a plurality of porous silica nanoparticles in which the pores are randomly oriented, a method for fabricating an optical coating, and the use of porous silica nanoparticles in which the pores are randomly oriented in the manufacture of an optical coating.

The invention relates to an optical coating, comprising porous silica nanoparticles, or obtained from porous silica nanoparticles, in a suitable binder, which is transmissive preferably to visible light, and preferably provides anti-reflective properties, and optionally provides other additional functionality. The coating is particularly, but not exclusively, suitable for application to ophthalmics and eyewear, photovoltaic cells, displays, windows, light emitting diodes and solar concentrators.

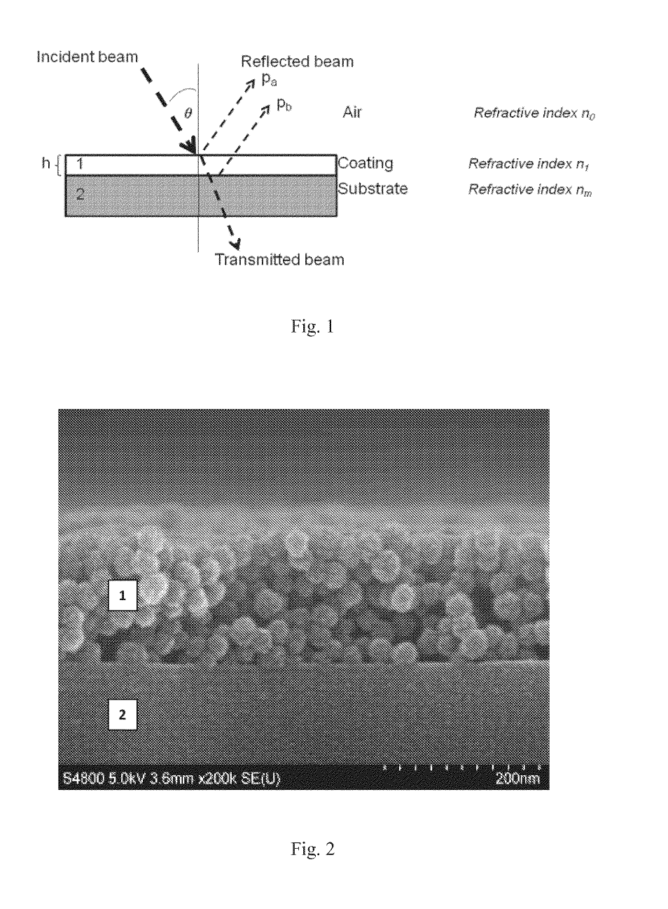

Eyewear, solar cells and displays generally consist of an outer substrate exposed to the environment consisting of a sheet of glass or polymer. These typically have a refractive index of 1.5-1.7 and reflect about 4-5% of incident sunlight on each surface—energy which reduces visibility through the substrate or which is lost to a solar cell. These substrates may be coated with an anti-reflective coating layer that reduces this reflection to less than 2%. FIG. 1 illustrates schematically a conventional single-layer anti-reflective (AR) coating 1 on a substrate 2. The thickness of the AR coating 1 is h. The reflectance is reduced if the light reflected off the front and back surfaces of the AR coating 1 is arranged to destructively interfere. This is achieved (for normal incidence) if the thickness of the coating 1 is equal to a quarter of the wavelength of the incident light in the medium of the coating, i.e.:

$$h = \frac{1}{4} \frac{λ}{{n}_{1}}$$

where λ is the wavelength of the light in vacuum, and n₁ is the refractive index of the coating. This assumes that the refractive index n₁ of the coating 1 is less than the refractive index nₘ of the substrate 2, such that there is a π phase change of the light reflected at the interface between the coating 1 and the substrate 2. The thickness h may, of course, be any odd integer multiple of one quarter of the wavelength of the light in the coating. For complete destructive interference, the amplitude of the two reflected waves must be equal to each other. This can be achieved if the refractive indices are matched such that:

n₁/n₀=nₘ/n₁

rearranging this gives:

n₁=\sqrt{n₀nₘ}.

For air n₀=1, and for glass nₘ=1.5, which gives the ideal refractive index of the coating as n₁=1.22.

The degree of reflection from a given lens is related to its refractive index, a higher refractive index resulting in greater reflection. At normal light incidence this may be simply calculated using the equation below—for a typical polycarbonate lens of refractive index nₘ=1.586, the reflection R is 5.1% per lens surface, giving a total of 10.2% reflected light.

R=(1−nₘ)²/(1+nₘ)²

Reflections are significantly enhanced at higher incident angles and even poorly reflecting surfaces can appear mirror-like at glancing angles. At an incident angle of 65° a typical lens will reflect over 25% of the light striking each surface. The equations describing this behaviour are known as the Fresnel Equations and further information can be found in any optics text, for example Hecht E, Optics, 2002 pp 113-122.

As mentioned above, the anti-reflective coating layer thickness governs the phase difference between the two waves and the refractive index of the layer governs the amplitude of the reflected waves. The behaviour of the coating system is described by the equation below, in which a coating of refractive index n₁ is applied to a lens of refractive index nₘ.

R=n₁²(1−nₘ)² cos² k₀h+(nₘ−n₁²)sin² k₀h/n₁²(1+nₘ)² cos² k₀h+(nₘ+n₁²)sin² k₀h

The terms k₀ and h refer to the phase angle of the incident light and the optical thickness of the film respectively. For an incident light wavelength of λ₀ and a film thickness of d=λ₀/4 n₁ equation 2 simplifies to:

R=(nₘ−n₁²)²/(nₘ+n₁²)²

Therefore, reflectance R=0% when the refractive index of the coating is the square root of the refractive index of the lens. So, for a polycarbonate lens, a 110 nm thick coating of refractive index 1.26 on a lens surface would have zero reflection at 550 nm, the centre of the visible spectrum.

This is the simplest solution to the reflection problem, but options for such a coating have been limited. Materials with the lowest known refractive indices tend to be fluorides such as MgF₂ (refractive index=1.38) or CaF₂ (refractive index=1.43) which only reduce the reflection from a typical lens surface to 1.3-1.5% and in any case are water soluble, necessitating encapsulation layers which further degrade the anti-reflective properties.

In eyewear applications AR coatings are used to increase transmission of light and reduce reflections within the inner lens surface that can be damaging to the eyes of the wearer.

In display applications, AR coatings are used to reduce reflectance that diminishes the viewability of the display, i.e. to reduce glare. Another desirable property of such coatings is a reduction in reflectance over a wide viewing angle. In such cases, the AR coating is primarily applied to plastic substrates although glass may also be used.

However, there are a number of problems with conventional AR coatings. There is difficulty in finding suitable coating materials with the desired low refractive index. The coatings are typically applied by techniques such as chemical vapour deposition (CVD) or physical vapour deposition (PVD) which require costly processing and are difficult to use with substrates other than glass, such as plastic windows for solar concentrators. In addition, the relatively inert surface chemistry of typical polymeric materials used for these components can lead to poor adhesion of subsequently coated layers.

The above analysis shows that optimal anti-reflective properties are only achieved at one wavelength for one particular angle of incidence; at other wavelengths and angles of incidence, the anti-reflectance deteriorates and so the efficiency of the solar cell or the readability of the display is reduced. Broadband AR coatings (ie coatings that provide useful anti-reflective properties over a range of wavelengths and angles of incidence) can be achieved by using multiple layers of coatings of differing refractive index, but this increases the complexity and cost of manufacture, which makes the solar cells or displays more expensive and less economically viable. There can also be problems (for example, adhesion) with applying AR coatings in addition to other functional coatings that may desirably be present on the solar cell, such as so-called ‘self-cleaning’ coatings.

It was proposed in this Applicant's earlier patent application WO 2010/106326 (filed before, but published after, the priority date of this application) that an effective broadband single layer anti-reflective coating can be formed by a simple low temperature wet chemical coating technique such as spin, dip, web or roll coating and such an anti-reflective coating would consist of porous silica nanoparticles of low refractive index and a binder used to provide mechanical strength.

For instance, US 2009-0220774A1 proposes using mesoporous silica nanoparticles consisting of a regular hexagonal array of pores formed by the use of a cationic surfactant which is used to template the pore structure. These particles are applied to a substrate before the coating is baked, preferably at a temperature of higher then 500° C. to remove the surfactants and densify the layer. However, this does not allow use on polymer substrates due to the high baking temperature. The lack of a binder system and the degree of sintering of the nanoparticles due to the baking reduce the mechanical flexibility of the system and its ability to withstand flex and impact.

JP 2009-40967 also proposes using a mesoporous silica nanoparticle system in which the particles are formed with a regular array of pores templated by a quaternary ammonium salt cationic surfactant. After particle formation, the surfactant is removed by washing in acid solution and an anti-reflective coating is formed by dispersing the particles in a binder system and depositing them on a suitable substrate prior to drying and curing the binder system. The regular structure of pores in the nanoparticle, and the nature of the surfactant, makes complete removal of the surfactant easier. However, this regular structure means that the pores are open to the ingress of the binder and solvent into the pore system by capillary forces. This ingress of binder and solvent degrades the anti-reflective performance by increasing the refractive index of the particles formed.

Chem. Mater. 2010, 22, 12-14 (Hoshikawa et al) describes particles in which the pores are essentially regularly spaced columns running throughout the particle. As a result of the curvature of the particle and the fact that any surface pore structure is not the lowest energy surface state, there is a slight widening and curvature of these pores at the particle surface. As the particle becomes smaller this distorted region at the particle surface becomes a larger proportion of the particle volume as a whole but the essential internal structure of the particle remains intact. Such a structure is conducive to capillary action and pore filing with a binder material as there is nothing to stop free flow of liquid through the pores.

It is an object of the present invention to alleviate, at least partially, some or any of the above problems.

A wide variety of silica nanoparticles are known in the art for a wide variety of applications. Within this broad range of applications, a particular type of silica nanoparticle is produced by NanoScape AG and sold under the trade names NMC-1-PH and NMC-1-Si. At the time the present invention was made, no use was known for these particles. It has been surprisingly found by the present inventors that these nanoparticles can be included in AR coatings to give improved optical properties.

The silica nanoparticles used in the present invention are porous, preferably substantially all of the pores (more preferably all of the pores) having a mean pore diameter in the range 1-10 nm, preferably in the range 1-5 nm, more preferably in the range 1-3 nm. The pores are randomly oriented. The pores of the nanoparticles preferably have an internal surface at least partially comprising a hydrophobic layer.

Accordingly, the present invention provides an optical coating comprising a binder and a plurality of porous silica nanoparticles in which the pores are randomly oriented.

The term “nanoparticles” is used in relation to this invention to refer to particles having an average diameter in the range 1-100 nm. Preferably, the nanoparticles have an average diameter in the range 1-50 nm, more preferably in the range 10-40 nm, even more preferably in the range 20-30 nm.

The term “randomly oriented” is used in relation to this invention to refer to pores which do not form a repeating (or partly or entirely symmetrical) structure. Examples of this are pores which have a tortuous path, and/or are disordered, and/or are non-uniform, and/or are non-periodic, and/or are irregular and/or are asymmetric.

The term “hydrophilic” is used in relation to this invention to refer to a substance whose surface has a water contact angle of less than 90°. The term “hydrophobic” is used in relation to this invention to refer to a substance whose surface has a water contact angle of greater than 90°.

This invention also relates to the combination of an optical coating as described above and a substrate.

The present invention also relates to a solution for forming an optical coating comprising a solvent a plurality of porous silica nanoparticles in which the pores are randomly oriented. In some embodiments, the solution also comprises a binder. In other embodiments, a further solution for forming an optical coating comprising a binder and a solvent is provided.

In addition, the present invention relates to the use of porous silica nanoparticles in which the pores are randomly oriented in the manufacture of an optical coating.

Another aspect of the invention provides a method of fabricating an optical coating, said method comprising:

preparing either (i) a solution for forming an optical coating comprising a binder, a solvent, and a plurality of porous silica nanoparticles in which the pores are randomly oriented, or (ii) two solutions for forming an optical coating, one comprising a binder and a solvent and one comprising a plurality of porous silica nanoparticles in which the pores are randomly oriented and a solvent;

applying the solution or solutions to a substrate; and

removing solvent from solution or solutions to form the optical coating.

It is preferred that the pores have an internal surface at least partially comprising a hydrophobic layer, the layer preferably being an organic layer, more preferably a polymer. It is preferred that the nanoparticles are distributed within the binder.

If two optical coating solutions are prepared in the method described above, they are preferably applied to the substrate separately and sequentially.

As mentioned above, it has been surprisingly found by the inventors that the silica nanoparticles described (which previously did not have any known use) can be formulated into an optical coating having improved properties. Without wishing to be bound to any theory, this surprising improvement is thought to be due to the porous silica nanoparticles having randomly oriented pores, this tortuous pore path having the effect of reducing liquid ingress (ie ingress of the binder in the optical coating). The pores may be coated with a thin (e.g. monolayer) organic layer, preferably a polymer—in some embodiments polystyrene. The nanoparticles used in the invention consist of a random collection of pores which are arranged in a complex tortuous path. This type of structure, optionally in conjunction with the hydrophobic internal pore coating, tends to block binder ingress into the particle core maintaining the low refractive index of the particles when they are immobilised in the binder.

The random orientation of the pores of the silica nanoparticles means that when the nanoparticles are formulated into a coating with a binder, the pores are primarily air filled (ie at least 50% of the volume of the pore is air) except for the thin organic internal surface. Due to the random nature of the internal pore structure there is preferably substantially no binder ingress into the pores. This allows the refractive index of the coating to be maintained at less than 1.20. This effect is enhanced if the pores have an internal surface at least partially comprising a hydrophobic layer and the binder is hydrophilic. Preferably, the external surface of the nanoparticles (ie excluding the pores) is hydrophilic.

The binder may be either inorganic or organic. In the optical coating, the binder surrounds the particles and acts to provide mechanical strength to the film. The binder is preferably a hydrophilic binder. Particularly preferred binders include tetraethoxysilane (TEOS) or MP-1154D (SDC Technologies). MP-1154D is a siloxane-based hardcoat comprising 3-glycidoxypropyltrimethoxysilane (GPTMS) and is known as a hardcoat in optical applications. However, it has been surprisingly found by the inventors that MP-1154D is a compatible binder with the silica nanoparticles described above in order to provide the optical coatings of the invention.

Selecting a binder which has similar properties to the underlying substrate (ie chemical compatibility such that the binder will adhere to the substrate) can reduce or substantially eliminate brittle and interface film failure even under loads that induce significant distortion to the coating. Examples of suitable combinations include (i) a TEOS binder and a glass substrate, and (ii) a TEOS binder and a TAC substrate.

In some embodiments, the surface of the substrate to which the optical coating is to be applied is treated before application of the optical coating solution. In some embodiments, this surface treatment can be in the form of the application of a primer to the substrate or hardcoat in order to enhance adhesion between the coating and the substrate. Suitable primers include polyurethane based primers such as PR1165, which is polyurethane in water. PR1165 is particularly suitable for use between a polycarbonate substrate and a layer comprising the siloxane MP-1154D.

In other embodiments, the surface treatment can involve altering the chemical or physical properties of the surface of the substrate. This can be done to increase the surface energy of the substrate. Such treatments can include treatment with an acid (eg hydrochloric or sulphuric acid) or a base (eg sodium hydroxide), or plasma or corona treatment. Acid or base treatment can hydrolyse the surface of a substrate, and all of these treatments can be used to oxidise and/or etch the surface of a substrate. Hydrolysing the bonds on the surface of the substrate can provide a more polar surface, thereby increasing polar interactions. Oxidising and etching can increase the surface roughness and contact area. Hydrolysis, oxidising and etching can all be used improve compatibility (and therefore adhesion) between the substrate and the binder.

Preferred substrates include polycarbonate, glass, triacetate cellulose (TAO) or polymethylmethacrylate (PMMA). These substrates, particularly the polycarbonate, may comprise a hardcoat (for example MP-1154D) onto which the optical coating is applied, either with or without a surface treatment such as application of a primer.

Preferred surface treatments for polycarbonate substrates (with or without a hardcoat as described above) include plasma treatment, preferably in oxygen (preferably 1 bar for 1 minute).

Preferred surface treatments for TAC substrates include treatment with a base. It is preferred that the base is sodium hydroxide, preferably in solution with water, normally at about 10% w/w concentration. It is preferred that treatment with a base is followed by washing with water.

Preferred surface treatments for PMMA substrates include treatment with an acid or treatment with a base. A preferred acid is sulphuric acid, preferably a 3M aqueous solution. A preferred base is ethylamine diamine, preferably a 1M solution in isopropanol. Preferably, treatment with an acid or base is followed by washing with water and/or IPA.

All substrates are preferably washed prior to use, either before or after surface treatment. Washing can be with a non-ionic surfactant solution and/or isopropanol and/or acetone and/or water, optionally with sonication. Preferably, the non-ionic surfactant has a hydrophilic polyethylene group and a hydrophobic group, such as Triton X-100 (preferably a 1 wt % solution in water). It is preferred that ultrasonication is followed by washing with water and/or isopropanol.

A further coating may be applied to the optical coating to improve its resistance to abrasion. A preferred coating comprises a perfluoropolyether with ethoxysilane terminal groups such as Fluorolink S10 (Solvay Solexis). Preferably this coating is applied as a solution in isopropanol, preferably with water and/or acetic acid.

Preferably, the solvent used in the optical coating solution(s) comprises an alcohol, more preferably isopropanol. Preferably, when the binder is TEOS, the optical coating solution includes an acid, preferably hydrochloric acid. The hydrochloric acid catalysis the hydrolysis of TEOS, the hydrolysis releasing an alcohol and producing reactive silanol (Si—OH) groups. These silanol groups then undergo a condensation reaction which forms—Si—O—Si— bonds, resulting in a continuous silica network. The inclusion of an acid is also advantageous because it slows the condensation reaction, resulting in polymeric silica chains that are not large enough to scatter light (ie keeping the material optically transparent).

Preferably the optical coating is an anti-reflective (AR) coating. The term “anti-reflective coating” is used in relation to the present invention to refer to a coating which, when applied to a substrate, reduces the amount of incident light (or other electromagnetic radiation) which is reflected by the substrate.

Preferably the optical coating can exhibit a hardness of typically greater than 0.7 GPa, or more preferably greater than 1.0 GPa, as measured by nanoindentation. Also preferably, the coating has an elastic modulus greater than half and less than twice the elastic modulus of the underlying substrate. More preferably the coating has an elastic modulus within ±25%, even more preferably ±10%, in some embodiments substantially identical to, the elastic modulus of the substrate. In this way the elastic modulus can match the underlying substrate, which indicates that the film is capable of significant flex. It is preferred that the coating embodying the invention will flex without brittle failure (ie without plastic deformation, for example cracking and/or delamination) to ten times (preferably greater than 10 times) the coating thickness on flexible substrates, for example polymer substrates. This flex is even seen when a coating comprising an inorganic binder is used on a polymer substrate.

This surprising result is another aspect to the composite porous silica-organic structure of the nanoparticles.

The coating typically has a refractive index in the range 1.0 to 1.4. It is preferred that the coating has a refractive index of ±20% of the square root of refractive index of the substrate, more preferably ±15%, even more preferably ±10%. A glass substrate typically has a refractive index of 1.5, a polycarbonate substrate normally has a refractive index of 1.58. The binder will typically have a refractive index of about 1.5 and the nanoparticles have a refractive index of about 1.16. The refractive index of the mixture of the particles and the binder can therefore be tailored to a specific substrate by varying the ratio of binder to nanoparticles. This allows the system to optimise the refractive index of the coating to minimise the reflectivity of the optical coating in the case of an anti-reflective coating film.

Preferably, the reflectance for incident light on a substrate having one surface coating with the optical coating of the invention at at least one wavelength in the range from 300 nm to 1900 nm is less than 2%, more preferably less than 1.5%.

In the present specification, the term “optical” is used, for example in “optical coating”; however, this term is not intended to imply any limitation to visible light only. The invention may, if required, be applied to other parts of the electromagnetic spectrum, for example including at least ultraviolet (UV) and infrared (IR). The coating of the invention is also referred to as a film in some contexts.

Embodiments of the invention will now be described, by way of example only, with reference to the accompanying drawings, in which:

FIG. 1 is a schematic illustration of a conventional uniform-thickness, single-layer AR coating provided on a substrate;

FIG. 2 is a Scanning Electron Micrograph of a cross-section of the optical coating of the invention on a glass substrate for solar cell applications;

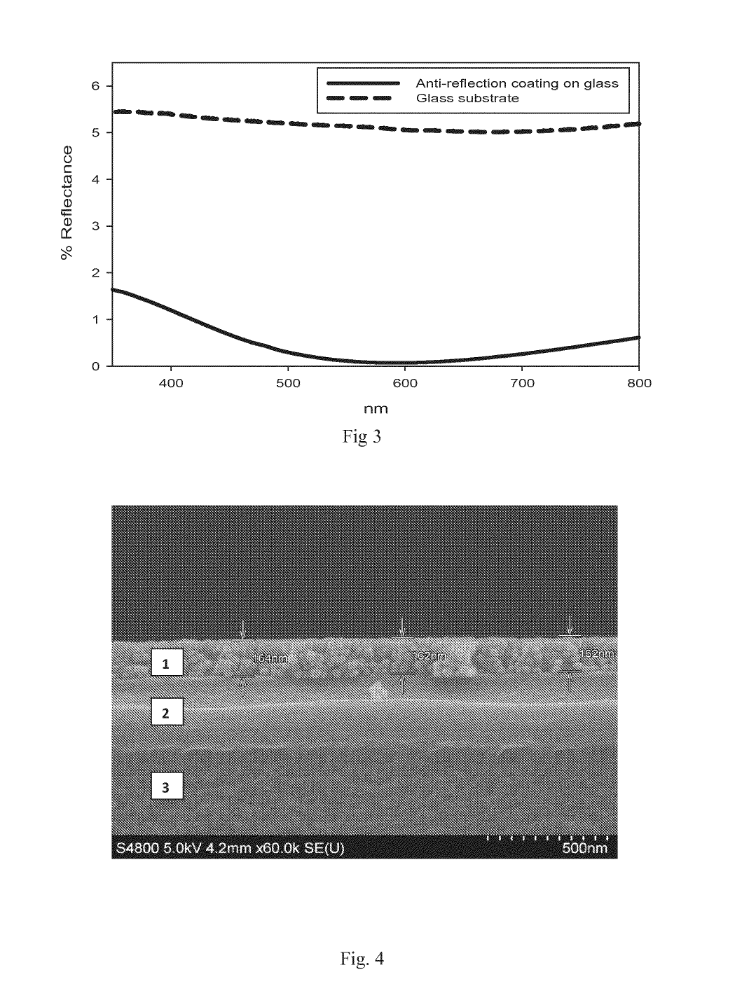

FIG. 3 is a reflectance curve in the visible wavelength range showing the anti-reflective performance of the optical coating of FIG. 2;

FIG. 4 is a Scanning Electron Micrograph of a cross-section of the optical coating of the invention on a silicone hardcoated polycarbonate (PC) substrate for use in ophthalmic applications;

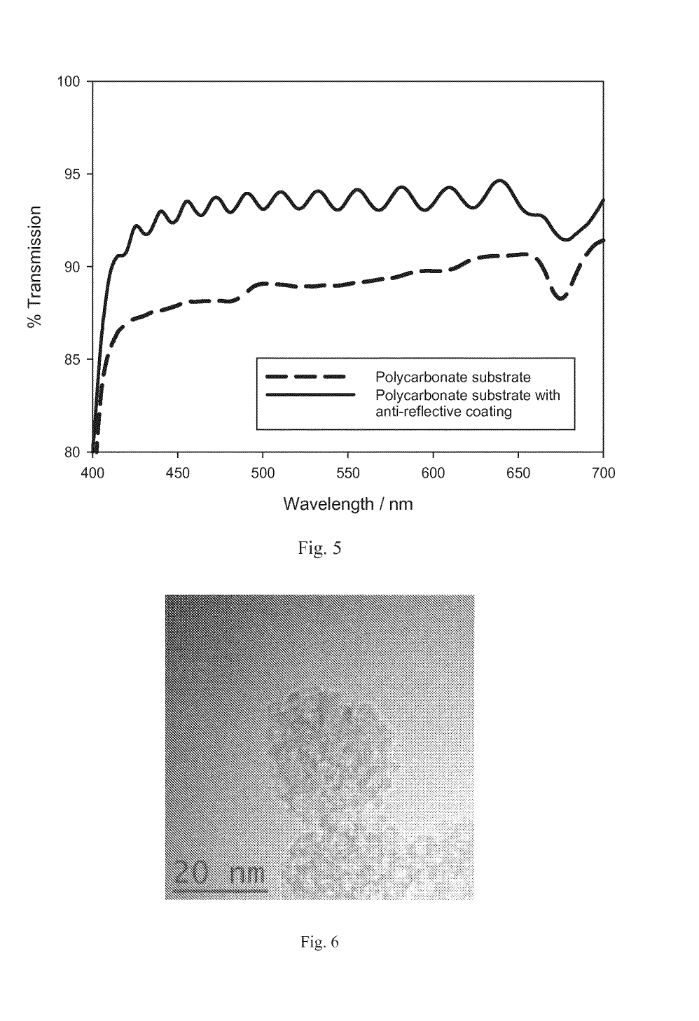

FIG. 5 is a transmission curve showing the anti-reflective performance of the optical coating of FIG. 4; and

FIG. 6 is an Transmission Electron Microscopy (TEM) image of a silica nanoparticle of the invention.

The nanoparticles of the invention preferably have an open or porous structure. An example of such a particle is shown in FIG. 6. These porous particles are used in the anti-reflective coatings of the invention because the porous nature of the material and the random orientation of the pores reduces the refractive index (i.e. the refractive index becomes an average of that of air and the material of the particles). As such, the coatings may be applied to a surface and provide a refractive index close to halfway between glass and air.

The pores of the nanoparticles are preferably at least partially coated with a hydrophobic layer, preferably an organic layer, more preferably a polymer. The organic and/or polymer layer can comprise phenyl or alkyl groups. These groups can be substituted with halogen and/or amine groups. In some embodiments, the organic layer comprises one or more trialkylamines or triethanolamine. The polymer can be in a monolayer. The polymer can comprise, for example, an organic polymer. In some embodiments, the polymer can comprise polystyrene and/or poly vinyl butadiene. The hydrophobic layer is preferably less than 50 wt % of the weight of each particle, more preferably less than 40 wt %, even more preferably less than 30 wt %.

Most preferably, the porous particles are in the size range 20-30 nm in order to reduce any surface roughness of the film to less than 30 nm.

### SYNTHESIS OF PARTICLES FOR USE IN EMBODIMENTS OF THE INVENTION

Porous silica nanoparticles are typically prepared by the hydrolysis of an alkoxysilane (such as tetramethylorthosilicate and tetraethylorthosilicate) followed by co-condensation of the hydrolysed precursor to produce an inorganic silica polymer. To produce particulate structures the reaction is catalysed by the presence of a base, which accelerates the condensation reaction. Any suitable base may be employed, for instance ammonia, NaOH or KOH. Thus the reaction is typically performed in an alkaline solution, which is typically an aqueous solution of the base. Typically this reaction will result in large, dense spherical silica particles.

The inclusion of a polymeric templating agent results in structural modification of the particle and the development of a randomly oriented pore structure. For example, if polystyrene is polymerised in the same solution as the above reaction, then the space occupied by the organic polymer cannot be occupied by the silica, and hence the silica grows around the polymer, resulting in an intimately mixed organic/inorganic particle. Removal of the templating polymer, by a solvent that dissolves polymer and not silica, results in a silica particle with pores resulting from the polymer removal. Polymer removal is never complete because the surface energy increase of completely removing the polymer from the silica surface is too large. Hence a degree of polymer coating is retained within the silica nanoparticles on the internal surfaces of the pores.

The overall particle size is controlled by forming an oil in water emulsion. The emulsion droplets act to halt growth of the particle beyond the domains of the droplet. The droplet size is controlled by the ratio of oil, water and emulsifying agent type and concentration. Under appropriate conditions, particle diameter and distribution of diameters can therefore be kept within a preferred range of 20-30 nm.

The porous silica particles, fabricated as described above, are such that the pore structure is randomly oriented and the internal surface of the pores is coated with a hydrophobic layer and the external surface of the particle is hydrophilic.

Optical Coating

The particles are used to create a coating layer on a substrate, such as glass or polymer. The coating preferably has a mean thickness in the range from 75 to 500 nm, more preferably 75 to 300 nm, even more preferably 100 to 200 nm. It is preferred that the coating has a average surface roughness in the range from 2 to 50 nm, more preferably 5 to 30 nm, even more preferably 10 to 30 nm, as measured by atomic force microscopy (AFM) or interferometry.

The optical coating may be obtained by formulating the particles above in a binder and a solvent to form an optical coating solution.

The binder may comprise at least one of silicate, silica, silicone based polymer, siloxane based polymer, acrylate based polymer, cellulose, cellulose derivatives, or vinyl alcohol.

As mentioned above, the coating solution of the present invention comprises a solvent. The solvent preferably comprises an alcohol, preferably at a level of at least 50% v/v. Preferred alcohols include methanol, ethanol, propanol or butanol. A particularly preferred alcohol is isopropanol.

The coating solution may additionally comprise other components such as water, acid (preferably hydrochloric acid), and/or silicone. These additional components are useful in controlling the viscosity of the coating solution and the dispersion of the particles.

The coating solution described above can be applied to a substrate by standard wet chemical coating techniques, including but not limited to spin coating, dip coating, roll to roll coating, spray coating and webcoating on a substrate.

The substrate may be, for example, one of glass, quartz, polycarbonate, silicone hardcoated polycarbonate, acrylate coated polycarbonate, polymethyl methacrylate, polyethylene terephthalate (PET), polyethylene naphthalate (PEN), or cellulose triacetate (TAO).

The coating solution may be dried and optionally cured on the substrate to form the optical coating. The drying is a process to remove the solvent, optionally involving heating. The drying can be performed simultaneously with the curing or can constitute a separate process. In some embodiments, the curing is performed by maintaining the temperature in the range of from 50 to 250° C., more preferably from 80 to 140° C.; alternatively UV curing is performed at ambient or elevated (ie above 25° C.) temperature. The elevated temperature used can be chosen by the skilled person depending upon the substrate and on the binder.

The combination of the optical coating and the underlying substrate can be matched by manipulation of the ratio of particles to binder and by the choice of binder. It is preferred that the optical coating comprises 40-60 wt % nanoparticles, more preferably 48-54 wt %, even more preferably 50-52 wt %, most preferably about 51 wt %, preferably when the substrate has a refractive index of 1.5. Preferably, the reminder of the optical coating is the binder and optionally any additives which have been used. This matching allows the coating to flex under continuous pressure or during an impact, for example from a sand particle hitting the surface whilst maintaining the hardness of the optical coating.

### EXAMPLES

### Example 1

### Optical Coating on Glass Substrate for Solar Cell Applications

A solution of 1.4% w/v mesoporous silica nanoparticles (as described above) in methanol was used as a source of particles (Solution A). The mean particle diameter of the mesoporous silica particles was 20-30 nm. A binder solution comprising 100 μl tetraethyl orthosilicate (TEOS), 2 ml isopropanol (IPA) and 50 μl hydrochloric acid was prepared (Solution B). Glass substrates were prepared by washing in acetone at 60° C. for 10 minutes, IPA at 60° C. for 10 minutes and then dried. The dimensions of the substrates were 25 mm×25 mm.

The optical coating was prepared using a spin coater. A substrate was spun at 4200 rpm and 270 μl of Solution B was deposited on the substrate which continued spinning for 25 seconds. Following this 270 μl of Solution A was deposited on the substrate which was spun at 4200 rpm for 25 seconds. These two deposition steps were then repeated to give a final coating with the required optical and mechanical properties.

The structure of the optical coating formed is shown in cross-section in FIG. 2, in which the optical coating (1) is on the glass substrate (2); the reflectance properties in comparison to an uncoated glass substrate are given in FIG. 3. As can be seen, the reflectance for all wavelengths of visible light in the range from 390 to 750 nm is less than 2%, and in fact less that 1.5%. These low reflectances can also be achieved for wavelengths in the range of from 300 to 1900 nm.

### Example 2

### Silica Particles and Silicone Binder on Polycarbonate Substrate for Ophthalmic Applications

1 g of a solution (4.7% wt in ethanol) of mesoporous silica nanoparticles (as described above), was diluted with 2.35 ml of Isopropanol to obtain a 1.4% wt solution (Solution A). A thermally curable hardcoat MP1154D from SDC Coatings (Anaheim, Calif.) was used as a binder. A binder solution of 1 ml MP1154D was diluted with 1 ml of Isopropanol to obtain a 10 wt % binder solution (Solution B). 3.4 ml of Solution A was mixed with 0.6 ml Solution B to obtain the optical coating solution (Solution C). A polycarbonate lens was primed with PR-1165 (SDC) and hardcoated using MP-1154D (SDC). The lens was then spun at 4000 rpm for 60 s. 500 μl of Solution C was deposited onto the centre of the lens during spinning. The resulting optical coating was then cured in air at 129° C. for 4 hours to produce the coating structure shown in FIG. 4, comprising the optical coating (1), the silicone hardcoat (2) and the polycarbonate substrate (3). The transmission of the substrate with and without the anti-reflection layer (optical coating) is shown in FIG. 5; the greater transmission with the coating demonstrates the reduction in reflection.

### Example 3

### Silica Particles and TEOS Binder on Polycarbonate Substrate with MP-1154D Hardcoat and Plasma Treatment

Polycarbonate plaques measuring 5×5 cm coated with an MP-1154D hardcoat were plasma treated in oxygen using a Pico System plasma treater at 50% power and 1 Bar oxygen for 1 minute.

A solution of 1.5 g of 5 wt % SiO₂ mesoporous silica particles in isopropanol was diluted with 13.5 g of isopropanol. A binder solution was prepared from 4.5 g of tetraethoxysilane, 20 g of HPLC grade isopropanol and 0.5 g of 1M HCl and mixed with the diluted mesoporous silica colloid to form an optical coating solution. The PC plaques were then dip coated in the solution and withdrawn at 80 mm/min. The substrate was then dried in ambient air for 30 seconds before repeating the dip process 4 times. The silica particles constituted 51 wt % of the resultant optical coating on the substrate.

The maximum transmission of these samples was 97.8% (measured using UV/VIS spectroscopy) and the coatings were tissue abrasion resistant. For all examples, abrasion resistance was tested in accordance with BS ISO 9211-4:2006 Optics and optical instruments—Optical Coatings. Part 4 Specific Test Methods. This involved 10 strokes with cheese cloth/tissue or steel wool.

Additionally, a hydrophobic top coating was applied without a significant detrimental effect on the optical properties of the ARC. To achieve this, a solution was prepared consisting of 150 g is HPLC grade isopropanol, 6.4 g of deionised water, 1.6 g of Fluorolink 510 (Solvay Solexis) and 1.6 g of acetic acid. A single layer coating was applied by the dipping process described above using this solution. Optical properties were unaffected however steel wool abrasive resistance was gained.

### Example 4

### Silica Particles and TEOS Binder on Glass Substrate with MP-1154D Hardcoat

The same coating solution was used as described above, however the substrate was replaced by a glass microscope slide. The slide was washed by ultrasonication using Triton X-100 for 10 minutes followed by thorough rinsing with deionised water and dried using compressed air. No further surface treatment was used.

The slide was prepared as described above and it had a maximum transmission of 98.5% and tissue abrasion resistance. Again, the silica particles constituted 51 wt % of the resultant film on the substrate. Application of the hydrophobic Fluorolink 510 coating provided steel wool abrasion resistance.

### Example 5

### Silica Particles and MP1154D Binder on Polycarbonate Substrate (CR-39) with NaOH Treatment

CR39 lenses were ultrasonicated in a 1 wt % solution of Triton X-100 for 10 minutes followed by a thorough rinse with deionised water, rinse with HPLC grade isopropanol and dried using compressed air. The lenses were then immersed in a 10 wt % sodium hydroxide solution for 10 minutes at room temperature.

A solution of 1.4 wt % mesoporous silica nanoparticles in isopropanol, referred to as the “particles”, was mixed with a solution of 10 wt % MP-1154D (diluted from the as supplied 20% wt solution using HPLC grade isopropanol), referred to as the “binder”, to form the optical coating solution. The two solutions were mixed in the ratio of 88 wt % particle with balance of binder.

The concave lens surface was coated by dispensing 500 μL of the ARC solution followed by spinning of the lens to 4000 rpm for 30 seconds. The convex surface of the lens was first spun to 4000 rpm before dispensing 1000 ul of the ARC solution on the lens centre followed by spinning for a further 30 seconds.

The lenses were cured for 3 hours at 110° C. The silica particles constituted 50.7 wt % of the resultant film on the substrate. The resulting coating increased the maximum light transmission of the lens from 88% to 97% and was resistant to manual abrasion with tissue.

### Example 6

### Silica Particles and MP1154D Binder on Polycarbonate Substrate (CR-39) with MP1154D Hardcoat and NaOH Treatment

CR39 lenses were ultrasonicated in a 1 wt % solution of Triton X-100 for 10 minutes followed by a thorough rinse with deionised water, rinse with HPLC grade isopropanol and dried using compressed air. The lenses were then dipped in PR-1165 and withdrawn at a rate of 252 mm/min followed by 15 mins air drying. The lenses were dipped in MP-1154D hardcoat solution and withdrawn at 252 mm/min. The lenses were cured at 110° C. for 3 hours. The fully cured lenses were immersed in a 10 wt % solution of sodium hydroxide for 10 minutes at room temperature.

A solution of 1.4 wt % mesoporous silica nanoparticles in isopropanol, referred to as the “particles”, was mixed with a solution of 10 wt % MP-1154D (diluted from the as supplied 20% wt solution using HPLC grade isopropanol), referred to as the “binder”, to form the optical coating solution. These two solutions were mixed in the ratio of 88 wt % particle with balance of binder.

The concave lens surface was coated by dispensing 500 μL of the ARC solution followed by spinning of the lens to 4000 rpm for 30 seconds. The convex surface of the lens was first spun to 4000 rpm before dispensing 1000 ul of the ARC solution on the lens centre followed by spinning for a further 30 seconds.

The lenses were cured for 3 hours at 110° C. The silica particles constituted 50.7 wt % of the resultant film on the substrate. The resulting coating increased the maximum light transmission of the lens from 88% to 97% and was resistant to manual abrasion with tissue.

### Example 7

### Silica Particles and MP1154D Binder on Polycarbonate Substrate with MP1154D Hardcoat and Plasma Treatment

Pre-prepared PC lenses coated with the SDC Technologies MP-1154D hardcoat were used as received from The Norville Group. Lenses were placed in a Pico plasma treater set at 50% power and 1 Bar pressure oxygen for 1 minute.

A solution of 1.4 wt % mesoporous silica nanoparticles in isopropanol, referred to as the “particles”, was mixed with a solution of 10 wt % MP-1154D (diluted from the as supplied 20% wt solution using HPLC grade isopropanol) referred to as the “binder”, to form the optical coating solution. These two solutions were mixed in the ratio of 88 wt % particle with balance of binder.

The concave lens surface was coated by dispensing 500 μL of the ARC solution followed by spinning of the lens to 4000 rpm for 30 seconds. The convex surface of the lens was first spun to 4000 rpm before dispensing 1000 ul of the ARC solution on the lens centre followed by spinning for a further 30 seconds.

Lenses were then cured by heating to 129° C. for 4 hours. The silica particles constituted 50.7 wt % of the resultant film on the substrate. The resulting coating increased the maximum light transmission of the lens from 91% to 97% and passed manual abrasion with tissue.

### Example 8

### Silica Particles and TEOS Binder on Triacetate Cellulose Substrate with NaOH Treatment

A triacetate cellulose (TAC) substrate was washed in a 1 wt % solution of Triton X-100 for 10 minutes to remove dirt from the surface, after which it was rinsed with deionised water to remove traces of the Triton solution. Each sample was then pre-treated in sodium hydroxide (NaOH) solution at 10% weight concentration for a total of 5 minutes. The samples were then rinsed extensively in deionised water and dried with compressed air to remove NaOH.

A 1.4 wt % mesoporpous silica particle solution was prepared from a 5 wt % solution by dilution in methanol (solution A). A tetraethoxysilane (TEOS) binder solution was prepared in a 3.5:40:3.5 ratio of TEOS:isopropanol:0.1M hydrochloric acid (solution B). An antireflective coating solution (solution C) was then prepared from a combination of solution A and solution B in a 3:2 ratio respectively.

Solution C, the prepared anti-reflective coating solution, was then spin coated onto the pre-treated TAC substrate. There was a small wait time of about 10 seconds between each coat to allow the previous coating to dry before application of the next. The silica particles constituted 50.7 wt % of the resultant film on the substrate.

Samples were prepared with two coats of the anti-reflective coating on both sides of the substrate, as well as two coats on one side of the substrate. An uncoated substrate was also tested. The optical properties of the samples are shown in Table 1 below. These results show that the application of two coats of the antireflective coating on both faces of the substrate gave maximum optical properties.

TABLE 1

| TAC with x number of coats: | Optics (% transmission) |
|---|---|
| 0 coats, blank substrate | 92.88 |
| 2 coats, both sides of substrate | 99.50 |
| 2 coats, single side of substrate | 96.03 |

### Example 9

### Silica Particles and MP1154D Binder on poly(methyl methacrylate) (PMMA) Substrate with Acid Catalysed Hydrolysis

PMMA substrate was sonicated in a 50 wt % aqueous isopropanol (IPA) solution for 10 minutes and dried with compressed air to hydrate and clean the polymer surface. The PMMA was then soaked in a 3M solution of sulphuric acid at 60° C. for 20 minutes. Following this the sample was rinsed with copious volumes of water, followed by IPA and dried with compressed air.

A 5% wt solution of SiO₂ mesoporous silica particles were diluted to 1.4% wt in isopropanol, referred to as the “particles”. A binder solution was prepared using MP-1154D and diluting this from approximately 20 wt % solids to 10 wt % solids. The mesoporous silica particles and the binder were combined at a ratio of particles to binder to give the optical coating solution. This mixture was then applied by spin coating.

For a ratio of 85% particles to 15% binder an optical transmission from a single coated side gave 93.96% maximum transmission. The silica particles constituted 50.7 wt % of the resultant film on the substrate.

### Example 10

### Silica Particles and MP1154D Binder on PMMA Substrate with Aminolysis

PMMA substrate was sonicated in a 50% wt aqueous IPA solution for 10 minutes and dried with compressed air to hydrate and clean the polymer surface. The PMMA substrate was immersed in a solution of ethylene diamine (1M in IPA) for 20 minutes at room temperature. Following this the sample was rinsed with plenty of water, rinsed with IPA and dried with compressed air.

A 5% wt solution of SiO₂ mesoporous silica particles was diluted to 1.4% wt in isopropanol, referred to as the “particles. A binder solution was prepared using MP-1154D and diluting this from approximately 20 wt % solids to 10 wt % solids. The mesoporous silica particles and the binder are combined at a ratio of particles to binder to give the optical coating solution. This mixture was then applied by spin coating.

For a ratio of 85% particles to 15% binder an optical transmission from a single coated side gave 93.7% maximum transmission. The silica particles constituted 50.7 wt % of the resultant film on the substrate.

### Example 11

### Silica Particles and TEOS Binder on Polycarbonate Substrate with Siloxane Hardcoat

Prehardcoated (siloxane hardcoat) polycarbonate lenses supplied by The Norville Group were plasma treated in the Pico plasma treater set at 50% power and 1 Bar pressure oxygen for 1 minute.

A 5 wt % solution of SiO₂ mesoporous silica particles was diluted to 1.4 wt % in isopropanol, referred to as the “particles”. A binder consisting of 1.75 g tetraethoxysilane, 20 g of isopropanol and 1.75 g of 0.1M hydrochloric acid was made and stirred for 24 hours to allow hydrolysis. The binder and particles were combined in a ratio of 2:3 respectively to give the optical coating solution.

Following the plasma treatment, the optical coating solution was spun onto the lenses, left for half an hour to dry and then the solution spun down again. The maximum optical transmission of the lens was 95.99% on a single side. This passed tissue abrasion.

### Example 12

### Silica Particles and MP-1154D Binder on Resin Substrate with Refractive Index 1.6-1.8 (ie Mitsui Resin (MR) 1.6 and 1.8)

Lenses were prepared by washing in 1 wt % solution of Triton X-100 by sonicating in an ultra sonic bath for ten minutes. The lenses were then washed in deionised water, followed by a wash in isopropanol and dried with compressed air.

The lenses were then dipped in the primer (PR-1165), allowed to dry for 15 minutes then dipped into the hardcoat (MP-1154D) and part cured by heating to 30° C. for 40 minutes at 50% RH.

A 5 wt % solution of SiO₂ mesoporous silica particles was diluted to 1.4 wt % in isopropanol, referred to as the “particles”. A binder solution was prepared using MP-1154D and diluting this from approximately 20 wt % solids to 10 wt % solids. The mesoporous silica particles and the binder were combined at various ratios of particles to binder (see Table 2 below) to give the optical coating solution. Varying the ratio of particles to binder increases or decreases the optical transmission and the abrasion resistance of the resulting film coating. A compromise at the right ratio between these two properties needs to be sought for an optimum formulation displaying both good optical transmission and abrasion resistance.

The optical coating solution (ie the ARC solution) was then spun down onto the lens on both sides and cured for 4 hours at 110° C.

TABLE 2

| Ratio | Ratio | Optical | Wt % of particles in |
|---|---|---|---|
| Particles | binder | transmission | optical coating |
| 80 | 20 | 95.976 | 35 |
| 81 | 19 | 96.755 | 37.4 |
| 82 | 18 | 96.354 | 38.9 |
| 83 | 17 | 97.292 | 40.6 |
| 84 | 16 | 96.973 | 42.4 |
| 85 | 15 | 97.197 | 44.2 |

The optimum formulation was found to be 82:18 ratio, which showed good optical transmission and abrasion resistance.

### Example 13

### Ratio Experiment

A 5% wt solution of SiO₂ mesoporous silica particles was diluted to 1.4% wt in isopropanol. A binder solution was prepared using MP-1154D and diluting this from approximately 20 wt % solids to 10 wt % solids. The mesoporous silica particles and the binder were combined at various ratios of particles to binder (see Table 3 below) to give the optical coating solution. Varying the ratio of particles to binder increases or decreases the optical transmission and the abrasion resistance of the resulting film coating. A compromise at the right ratio between these two properties needs to be sought for an optimum formulation displaying both good optical transmission and abrasion resistance.

TABLE 3

| | % | | Wt % of | | | |
|---|---|---|---|---|---|---|
| | Parti- | | particles | | | |
| | cles in | % | in final | | Abrasion | |
| | solution | Solids | film | % T | resistant | Coating |
| Polycar- | 88 | 2.432 | 50.7 | 95.751 | Yes | Both |
| bonate | | | | | | sides |
| | | | | | | coated |
| Polymeth- | 86 | 2.604 | 49.5 | 95.485 | Yes | Both |
| ylmethac- | | | | | | sides |
| rylate | | | | | | |
| High | 82 | 2.948 | 47.2 | 96.354 | Yes | Both |
| refractive | | | | | | sides |
| index lens | | | | | | |
| Glass | 90 | 2.26 | 51.8 | 94.61 | Yes | One |
| | | | | | | side |
| CR39 | 88 | 2.432 | 50.7 | 96.838 | Yes | Both |
| | | | | | | sides |

### Example 14

### Application of Hydrophobic Coating to Substrate after Application of Silica Particle Coating Solution

A commercial hydrophobic perfluoropolyether with ethoxysilane terminal groups, known as fluorolink S10 (obtainable from Solvay Plastics) was formulated according to the specification in the technical data sheet, ie:

1 wt % fluorolink

1 wt % Acetic Acid

4 wt % Water

94 wt % IPA

This formulation was stirred together until the mixture was substantially homogenous. Forming a thin film of this formulation on the surface of a substrate reduced the surface energy of the substrate and therefore enhanced abrasion resistance of the ARC.

The substrate (polycarbonate with MP-1154D in this case) can either be dipped or spin coated. The substrate can be dipped into the hydrophobic solution with a withdrawal speed of 25 mm/min. Alternatively, the hydrophobic coating can be spin coated onto a substrate at 3250 rpm on the convex side, using 1000 μl of solution. The acceleration should be slowed down to 250 rpm so that the coating on the convex side is not pulled off or to reduce chuck marks from the spin coater. The concave coating was dispensed onto the lens first (500 ml) then spun up to speed of 4000 rpm for 1 minute.

It was found the best curing conditions were 2 hours 45 minutes at 129° C. in the oven. With the hydrophobic coating on both sides of the lens a maximum optical transmission of 95.839% was observed, in comparison to the ARC alone at 95.483%.

### Example 15

### Measurement of Hardness and Elastic Modulus of Coatings on Glass and Polycarbonate Substrates

Coatings of thickness 150 nm comprising of 20-30 nm mean particle diameter mesoporous silica nanoparticles (inc accordance with the invention) and a binder comprising silicate were formed on quartz and a silicone hardcoated polycarbonate substrate in accordance the procedure given in Example 1. The coatings were analysed using a Nanoindentor (Micro Materials UK) in order to ascertain the hardness and modulus of the optical coatings. The results are given in Table 4 below and show that the elastic modulus of the optical coating layer changes dramatically with a change in substrate. This demonstrates that the optical coating is structured such that flexing under an applied force, in this case an ultrafine diamond tip, occurs in the film such that the deformation matches that of the underlying substrate. Further analysis showed that the 150 nm thick anti-reflective coating flexes to 5 microns before failure; that is the film deforms to 33 times its own thickness before failure occurs. The arrangement of the particles provides strength and flexibility by virtue of each particle having multiple contact points with surrounding particles.

This eliminates brittle failure and film delamination under impact and renders the film suitable for outdoor applications such as solar cells and eyewear. For comparison, a typical hardcoated polycarbonate plaque has a hardness of 0.9 GPa and an elastic modulus of 9.0 GPa. A typical anti-reflective coating deposited by physical vapour deposition (e.g. supplied by Norville) showed that brittle film delamination begins when the indentor penetrates to the thickness of the film, approximately 200 nm, because there is no elastic deformation possible in such layers.

TABLE 4

| | Film Hardness | Film Elastic |
|---|---|---|
| Substrate | (GPa) | modulus (GPa) |
| Quartz | 1.5 | 63.2 |
| Silicone hardcoated polycarbonate | 1.1 | 7.3 |

### APPLICATIONS

The optical coating of the invention can be used numerous fields such as optics (including fibre optics), ophthalmics (eg ophthalmic elements such as lenses), displays (including both emissive and reflective displays, for example LCD backlit, LED and/or E Ink display such as that used in the Amazon Kindle), solar collection (including solar cells and components thereof, for example as an anti-reflective coating on an Si₃N₄ coating in a silicon solar cell), lighting components, windows (eg windows for buildings, vehicle windows (e.g. automotive), laser windows, self-cleaning windows, as well as anti-static windows such as ZnO:Al, indium tin oxide (ITO) or other transparent coated windows), glass for protecting pictures/paintings, display cases, fish tanks/aquaria, and instrument display panels. One exemplary application of the optical coating is on a glass or polymer window on top of a photovoltaic solar cell. The solar cell may be of any suitable kind, such as monocrystalline silicon, polycrystalline silicon, thin-film silicon and hybrid technologies. The optical coating may be used on other optical components, known as solar concentrators, used for collecting and directing sun light to a photovoltaic cell. Suitable polymer materials for such components include, but are not limited to, polyesters such as polyethylene terephthalate (PET) and polyethylene naphthalate (PEN), and polyolefins such as biaxially oriented polypropylene (BOPP). However, the optical coating embodying the invention may also be used in general displays, and general window applications—for example for thermal management of buildings. An optical coating embodying the invention can also be employed in ophthalmic elements, whether made of glass or plastics materials, for example spectacle lenses.

1. An optical coating comprising:
a binder; and
a plurality of porous silica nanoparticles in which the pores are randomly oriented.

2. A solution for forming an optical coating comprising:
a solvent; and
a plurality of porous silica nanoparticles in which the pores are randomly oriented.

3. A method of fabricating an optical coating, said method comprising:
preparing either (i) a solution for forming an optical coating comprising a binder, a solvent, and a plurality of porous silica nanoparticles in which the pores are randomly oriented, or
(ii) two solutions for forming an optical coating, one comprising a binder and a solvent and one comprising a plurality of porous silica nanoparticles in which the pores are randomly oriented and a solvent;
applying the solution or solutions to a substrate; and
removing solvent from the solution or solutions to form the optical coating.

4. The coating as claimed in claim 1, wherein the pores have an internal surface at least partially comprising a hydrophobic layer.

5. The coating as claimed in claim 4, wherein the binder is hydrophilic.

6. The coating as claimed in claim 5, wherein the binder is tetraethoxysilane or a siloxane-based hardcoat comprising 3-glycidoxypropyltrimethoxysilane.

7. The coating as claimed in claim 1, in which there is substantially no binder ingress into the pores.

8. The coating as claimed in claim 1, wherein at least 50% of the volume of the pores is air.

9. The coating as claimed in claim 1, wherein the nanoparticles have a mean pore diameter of less than 10 nm.

10. The coating as claimed in claim 1, wherein the nanoparticles have an average diameter in the range 20-30 nm.

11. The method as claimed in claim 3, wherein a surface of the substrate to which the optical coating is to be applied is treated before application of the solution or solutions, the treatment increasing the surface energy of the substrate.

12. The coating as claimed in claim 1, wherein the optical coating has an elastic modulus greater than half and less than twice the elastic modulus of the underlying substrate.

13. A solar cell, lens, lighting component, window or glass panel comprising an optical coating as claimed in claim 1.

14. The combination of a substrate and an optical coating as claimed in claim 1, wherein the coating has a refractive index of ±20% of the square root of the refractive index of the substrate.

15. A use of porous silica nanoparticles in which the pores are randomly oriented in the manufacture of an optical coating.
